(19) United States
(12) Patent Application Publication
(10) Pub. No.: US 2025/0033094 A1
(43) Pub. Date: Jan. 30, 2025

(54) STINGRAY SYSTEM

(71) Applicant: CODY AUSTIN, Carlin, NV (US)

(72) Inventor: CODY AUSTIN, Carlin, NV (US)

(21) Appl. No.: 18/225,521

(22) Filed: Jul. 24, 2023

(51) Int. Cl. B08B 3/02; B08B 3/08

(52) U.S. Cl. CPC B08B 3/024; B08B 3/08

(57) ABSTRACT

An industrial long reach high pressure water blaster capable of 15,000 psi water pressure and 140 Gallons per minute. RF system-controlled robotic hydraulics move the stinger (the robotic pinpoint spray lance wand, trigger and water nozzle) toward a debris site at the proper spray angle (substantially more accurate than a one-vector track like a handheld power washer). Two slew drives and associated hydraulic lines braced to a boom/robotic-arm via equidistant metallic brackets allow the stinger system to remotely reach most any debris site without undue vibration. The stinger system is therein capable of 360° pitch, roll and yaw movement to bring the high-pressure water to any location, even concealed debris locations 180′ away from the system's base.

### CLAIM OF PRIORITY

This application currently claims priority to no prior U.S. patent applications.

### TECHNICAL FIELD

This disclosure relates to the technical fields of hydro-blasting and robotics.

### BACKGROUND

Hydro-blasting/hydro-jet cleaning is an effective form of power washing, used to remove buildup and debris (scale) in tanks, agitators, cladding, etc. The hydro-blasters customarily use high pressure nozzles at the tip of a spray gun.

While the technology to shoot water as high as 30,000 PSI has existed for some time, no pressure washing system has heretofore solved the problem of getting the high-pressure water to a desired location in pinpoint fashion, especially when the scale is located on the inside of a tall tank. Customarily, makeshift scaffolding systems are built to physically carry or wheel a hydro-blaster to a debris site. Cleaners are often forced to use a 1″ hose tank tied with a rope, or temporarily rig a blaster to a crane, all of which must be continually moved and maintained by hand. Troublesome vibration then occurs, forcing replacement of valves and diaphragms. Furthermore, the process is ordinarily arduous and dangerous.

What is needed (and solved by the instant disclosure) is a radio-controlled robotic hydro-blaster using hydraulic power to bring the water nozzle to the debris.

### SUMMARY

Disclosed are a methodology and apparatus device for on-point hydro-blasting. Inter alia, the invention is an industrial, long reach, robotic 360° swiveling/rotating pressure water blaster capable of 15,000 PSI water pressure and 140 gallons per minute that functions without undue vibrations that would otherwise throw the system out of alignment or cause cracks in diaphragms and valves. The long reach 360° rotating boom and arm, and the proprietary “stinger” (spray gun and lance with wand for hydro blasting) are novel to the industry.

The invention features a unique, hydraulically-controlled “stinger” (on-point robotically controlled nozzle/spray gun and lance with wand). The power and hydraulic lines run along (and are braced to) the full length of the boom of the robotic multi-jointed arm for superior stability and maneuverability. The invention is unique in its superior maneuverability at such high GPM and pressure, previously unimaginable without the invention's unique engineering and design. A Radio Frequency controlled system accurately moves the hydraulically powered stinger to the debris site at the proper water-spray angle (not just along a one-vector track like a clumsy power washer).

In many aspects, the blaster features a 1″ high pressure feed hose, two hydro-hoses, a power cable, a proprietary control panel optionally mounted on the boom, an RF controller, two-way hydraulic solenoids, and a remote-control unit for the hydraulic-controls. Controls for the boom feature, in some embodiments, a handheld pendant-style joystick (4 functions). Older boom controls were primarily manually operated levers. The RF stinger assembly controller offers the stinger full 360° movement in all directions and all angles. The result is that the stinger (water gun & nozzle) is fully capable of 360° pitch, roll and yaw, bringing the pressure water to any precise location.

### BRIEF DESCRIPTION OF THE DRAWINGS

FIG. 1 depicts the robotically-controlled boom consistent with various embodiments (mounted on a base, herein a truck, truck not novel on its own, not a necessary element of the invention);

FIG. 2 depicts the robotically-controlled boom and articulated arm and stinger assembly, consistent with various embodiments;

FIG. 3 illustrates exemplar boom and arm range directions from a top aerial view consistent with various embodiments;

FIG. 4 depicts the distal end of the stinger spray mechanism (shaft-lance barrel, tip & nozzle), with optional directional/monitoring camera, consistent with various embodiments;

FIG. 5 depicts the distal end of the stinger assembly and the pivot to the stinger spray trigger mechanism and stinger spray (shaft-lance barrel, tip & nozzle), consistent with various embodiments;

FIG. 6 depicts the mount-brackets along the boom, holding hydraulic and power lines to the boom, stabilizing the system, consistent with various embodiments;

FIG. 7 depicts the brackets [braces/hose-holders/mounts] individually installed approximately 4 feet apart along the boom (for, e.g., a 170′ boom), consistent with various embodiments;

FIG. 8 shows the inside of the control panel for the stinger's stinger assembly, capable of moving its robotic arm, turret and pivot, the unit comprising four solenoids/cylinoids (electro-hydraulic valves that control fluid flow) consistent with various embodiments (in FIG. 8, only 3 out of the 4 solenoids are shown);

FIG. 9 shows the controller panel comprising control receiver, in some embodiments;

FIG. 10 depicts the four hydraulic lines coming out of the control panel, running down to the hydraulics, each line comprising a flow control valve, consistent with various embodiments;

FIG. 11 depicts one side of the stinger assembly tower, illustrating a slew drive and the necessary hydraulic movement mechanism to rotate (turret) and swivel (pivot) the stinger barrel.

FIG. 12 depicts the stinger assembly's hydraulic arm comprising a first slew drive [on inside-left of the figure] and a 90° piece, consistent with various embodiments;

FIG. 13 depicts a second slew drive, here the slew drive rotates the turret that holds the barrel and nozzle assembly (the stinger), consistent with various embodiments;

FIG. 14 depicts the one-inch-high [first] swivel piece, the 90° piece, and the second swivel piece, consistent with various embodiments.

FIG. 15 illustrates the arm mechanism's 90° swivel to the hammer lock to a 6″ nipple to another 90° piece to the barrel, consistent with various embodiments;

FIG. 15 illustrates the tower connected to the second slew drive connected to the turret, consistent with various embodiments;

FIG. 16 depicts the end of the stinger assembly's arm leading to the stinger's 1″ barrel, the barrel mount coming out from arm to stinger, consistent with various embodiments.

FIG. 17 illustrates the stinger assembly, its tower leading to its hydraulic arm, here shown pivoting the stinger up/down with full 360° motion along this Y-Axis as shown, allowing the stinger (the tip at the right of the drawing) to angle itself in any direction along this axis, illustrating how the stinger gun is positioned at a precision blasting debris point and desired angle, consistent with various embodiments;

FIG. 18 illustrates the transmitter unit of the RF stinger hydraulics movement flow+fluids controller, consistent with various embodiments.

FIG. 19 illustrates the joystick controller (here transmitter unit) for boom control, optionally a modular detachable unit as shown, consistent with various embodiments.

### DETAILED DESCRIPTION OF THE INVENTION

The herein-disclosed invention involves on-point hydro-blasting. The invention comprises a long-reach 360° rotating robotically-controlled boom and multi-jointed arm for hydro blasting The invention further features a unique remote RF-controlled hydraulic “stinger” (water jet wand gun and nozzle) assembly. The stinger is, inter alia, a pinpoint, RF-controlled robotically-maneuvered high pressure water gun & nozzle (spray gun).

The engineering & design of the stinger (water spray gun and lance with wand) allows superior stability and maneuverability at extremely high GPM and PSI pressure, previously unimaginable without the invention's unique engineering and design.

The invention features, inter alia, an industrial, long reach high pressure water blaster capable of 15,000 PSI water pressure and 140 gallons per minute. The power and hydraulic lines run along (bracketed to) the length of the boom (and the extending robotic arm) for superior stability.

The blaster features a 1″ high pressure feed hose (pumped in through 1″ inlet positioned at the base/truck in some embodiments), at least two hydraulic hoses, at least one power cable, a proprietary RF control panel (panel optionally mounted on the boom), a controller, and at least 4 two-way hydraulic solenoids/cylinoids for stinger 360° control).

Controls for the boom feature, in some embodiments, are through a handheld pendant-style joystick (4 primary functions of CNC wire-control). Older units may use manually operated levers. Optionally, RF controlled unit(s) may be used, or Bluetooth™. The radio transmitters of the system may be controlled by push buttons, joysticks or linear levers, or other appropriately safe mechanism.

Also featured are slew drive hydraulics, which are high pressure driven “swivels” inside the stinger mechanism (positioned at the base/proximal end of the stinger wand) to allow seamless movement. One drive is for 360° X-direction rotation and one drive for is for 360° Y-direction up/down movement).

The RF controller offers control of 360° movement in all directions and all angles for the stinger (the water gun wand and nozzle). One slew drive offers 360° movement in the Y (forward/backward) direction, and the other [second] slew drive offers 360° movement in the X (around/sideways) direction, therein offering full 360° pinpoint hydro-jet (stinger) positioning. The result is that the system's stinger is capable of 360° pitch, roll and yaw movement to bring the high-pressure water to virtually any location at the right blasting angle.

### DETAILED DESCRIPTION OF ILLUSTRATIVE EMBODIMENTS

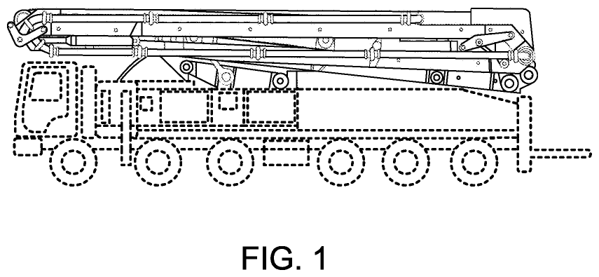

FIG. 1 depicts the stingray system mounted on a truck. The form of the system's base is substantially incidental so long as it provides sufficient stability and maneuverability, and is capable of housing the primary components of the stingray system).

In this embodiment, the stingray system is mounted atop the truck in its collapsed (non-deployed/stayed/resting) position. Along the length of the 170′ boom are positioned: a 1″ high pressure feed hose, 2 hydraulic hoses, and [here] one power cable(s).

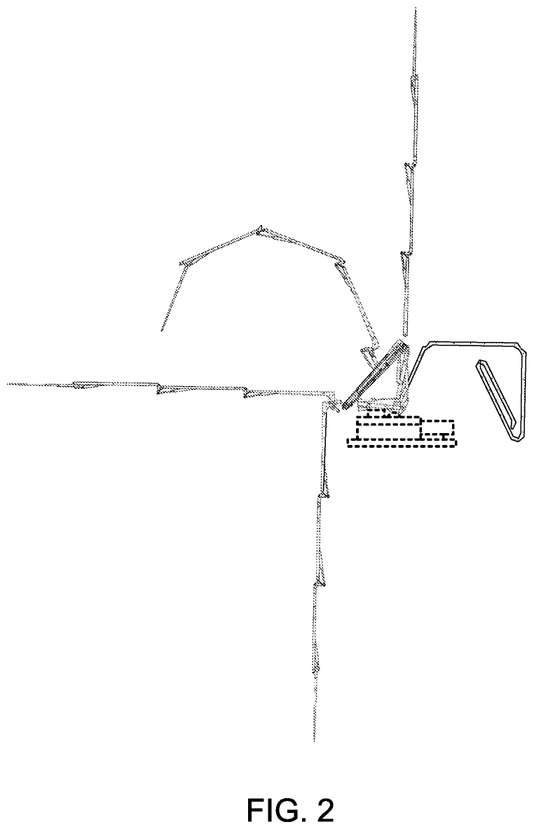

FIG. 2 illustrates the range and directional capacity of the system's robotic arm, allowing the stinger to reach a debris site even if the debris is located inside (e.g.) a mining tank positioned 170′ above the truck/system-base. The figure depicts the system's maximum 170′ height when deployed. In other embodiments, the length can range from about 35 meters to about 100 meters, depending on the pumper truck/base used.

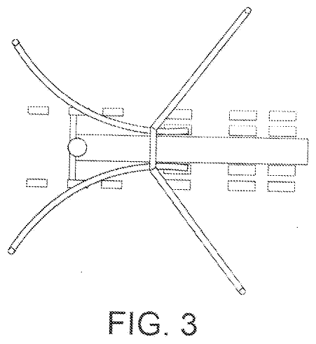

FIG. 3 illustrates, via aerial view, the wingspan-range and directional capacity of the system's robotic arm, allowing the stinger to reach even concealed debris sites, such as scale located on the inside circumference of a tank.

At ≤15,000 PSI, the ≤170′, the substantially-steel boom functions as an anchor against vibration. The hydraulic and power lines run internally through boom, counteracting the extreme vibration/shake caused by the high-water pressure.

Furthermore, the substantially square metallic mounts along the arm further dampen vibration (in one embodiment, these brackets and mounts are spaced 4′ apart). These brace-mounts are combined with metal couplers to reduce excessive vibration of the (high pressure-rated) rubber water hose. Alternatives to welded/bolted brackets & bracket mounts are possible; the square pipe bracket materials & shapes may vary so long as the hose-attachment devices appropriately secure the hoses, ensure liquid flow and dampen vibration for the full 180′ (max) boom length.

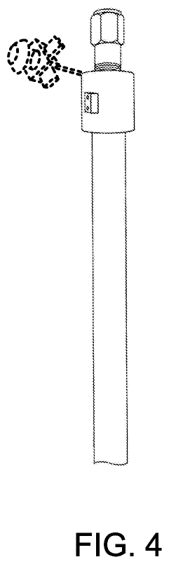

FIG. 4 illustrates the end/tip of the stinger shaft and the stinger nozzle. The “bulbous” cylinder near the proximal end of the nozzle is the “tip holder” (about ¾″ to about 1″ nozzle holder).

In one embodiment, the stinger movement mechanism is comprised of a 1″ high pressure quick-connect piece, connected to a 1″ 90°-degree bend piece, connected to a 1″ pressure swivel piece, connected to another 1″ 90°-degree bend piece, connected to another 1″ swivel piece, connected to another 1″-quick connect piece, connected to a 6″ nipple, connected to another 1″ 90°-degree bend piece, connected to a 1″×8″ rigid lance/pipe (herein synonymous with “barrel”). The tip is a 1″ to ¾″ nozzle holder, wherein the nozzle is a ¾″ diameter aperture with a #90 jet.

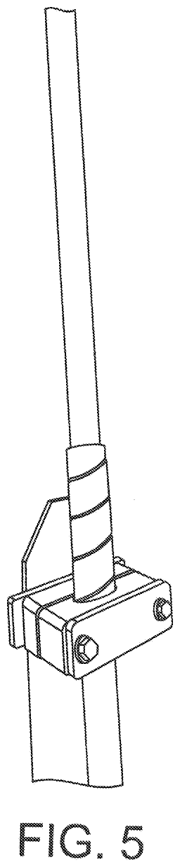

FIG. 5 depicts the stinger shaft. The figure further illustrates the mechanism assembly that moves the stinger, showing a 360° swivel piece at the base (proximal end) of the stinger shaft. This rotating portion of the arm illustrates how, when deployed near a debris site (such as the inside of a 170′ tank), the robotic arm positions the stinger near the debris the desired angle.

The control unit provides stinger rotation to direct the water at any angle (even if the debris is unseen, such as the internal surfaces of a tank). High pressure swivel pieces are positioned inside the stinger, one for 360° sideways rotation, and one for 360° front/back movement.

The control panel and unit is for the system's multi-jointed robotic arm. This unit comprises four cylinoids, a two-way radio controller, a transmitter & receiver. In some embodiments, the remote unit comprises an HBC radio remote control transmitter unit.

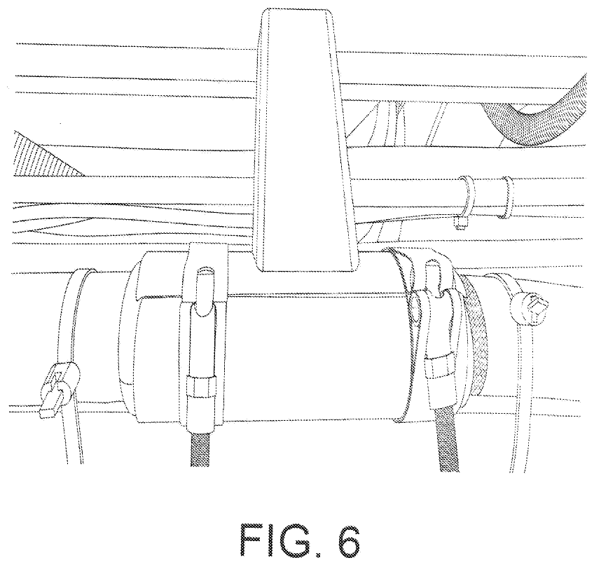

FIG. 6 depicts the brackets and metal couplers holding power, water and hydraulic lines fixed to the boom in order to stabilize the system (consistent with various embodiments). The mounts are substantially comprised of metal, substantially square tubing pieces which are welded to the boom. Other similarly stable attachment mechanisms are allowable.

Around the external circumference of the water line (or solvent line) is an isolation sleeve that goes over/around the hose, which is customarily made of plastic/plastic composite. Providing a buffer between metal mounts and the hose helps reduce vibration from the fast-flowing, high-pressure water. The brackets are, in one embodiment, spaced four feet apart along the boom and robotic arm. Other distance ratios are allowable so long as stability and durability are maintained.

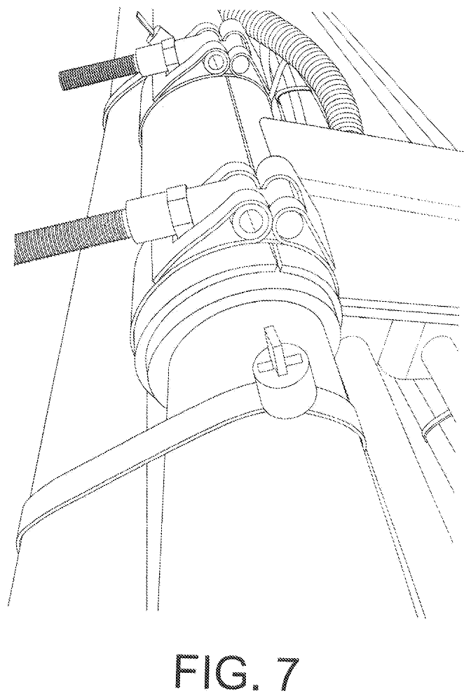

FIG. 7 depicts the brackets and metal couplers' holding power. Water, power and hydraulic lines are affixed to the boom in order to stabilize the system (consistent with various embodiments). In the preferred embodiment, the mounts are substantially comprised of metal, substantially square tube brackets welded to the boom. Other similarly stable attachment mechanisms are allowable.

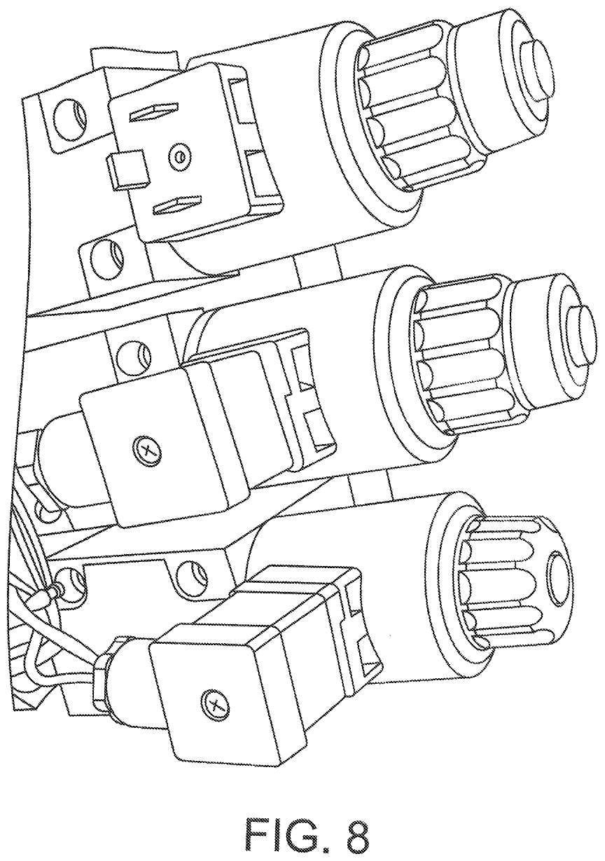

FIG. 8 shows the inside of the control panel (the RF control panel for the stinger's robotic arm) comprising four solenoids/cylinoids (electro-hydraulic valves that control fluid flow)), consistent with various embodiments. Only 3 out of the 4 solenoids are shown in this embodiment/figure.

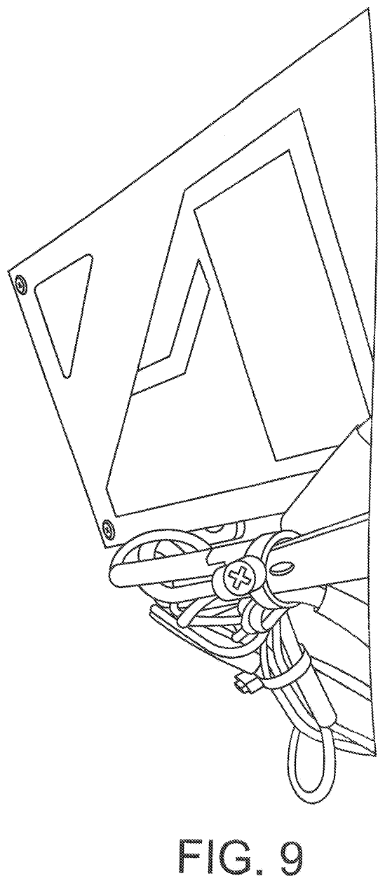

FIG. 9 shows the radio controller, comprising at least a transmitter and a receiver. In some embodiments, the controller is a proprietary RF control panel and unit optionally mounted on the boom. The stinger's remote is wireless, using an RF frequency to communicate between the control box, the control panel (optionally positioned on the boom)) and the hydraulic cylinder. In some embodiments, the remote unit is an HBC radio remote control transmitter unit.

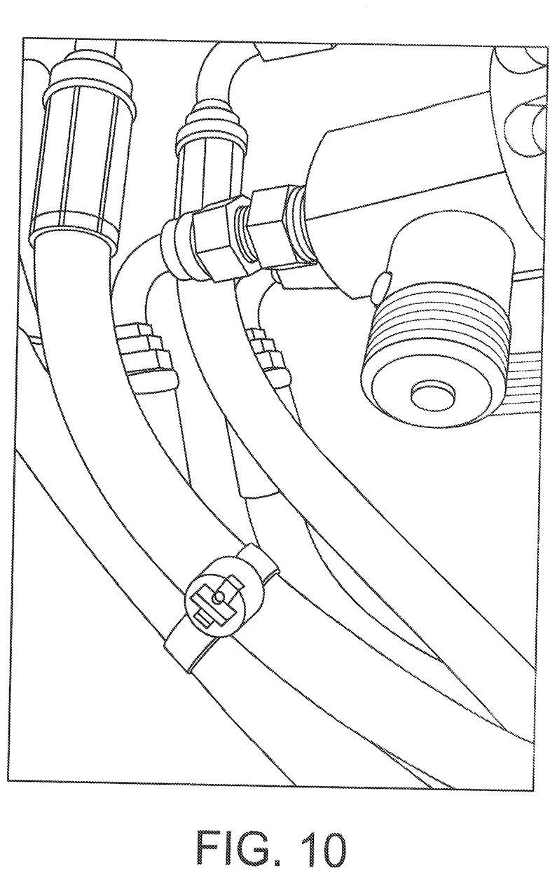

FIG. 10 depicts the four hydraulic lines coming out of the control panel, going down to the hydraulic motor and reservoir, each of the lines comprising a flow control valve.

In a preferred embodiment, Maximum Oil Flow is 158.5 gal/min/600 l/min, and Hydraulic Circuitry Type is MPS (machine protection system), providing smooth linear motion to the hydraulic actuator(s).

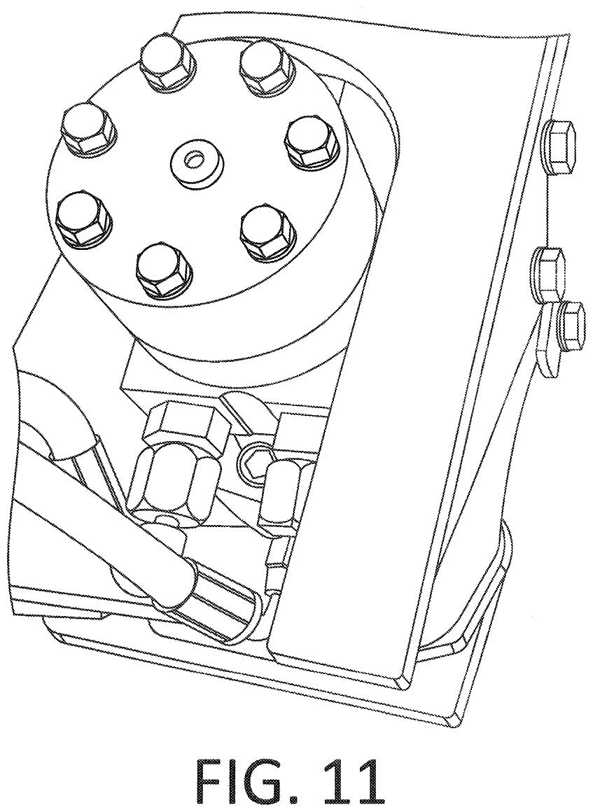

FIG. 11 depicts two hydraulic lines and slew drive motor.

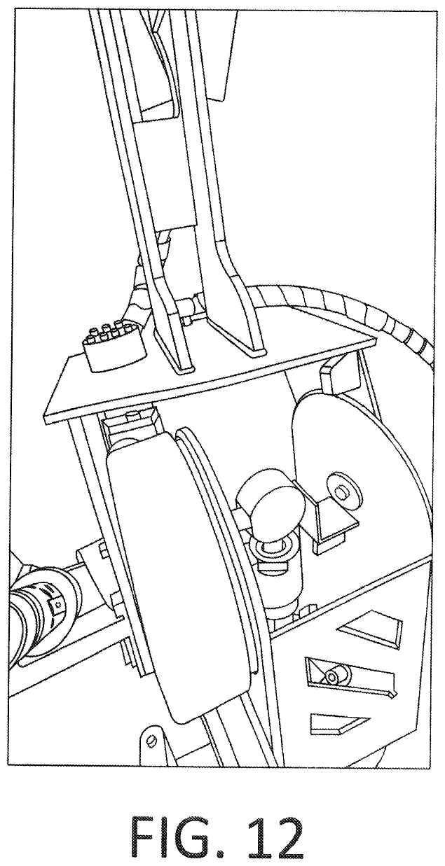

FIG. 12 depicts the boom mount, tower and robotic arm comprising a first slew drive [on inside-left of the figure], consistent with various embodiments;

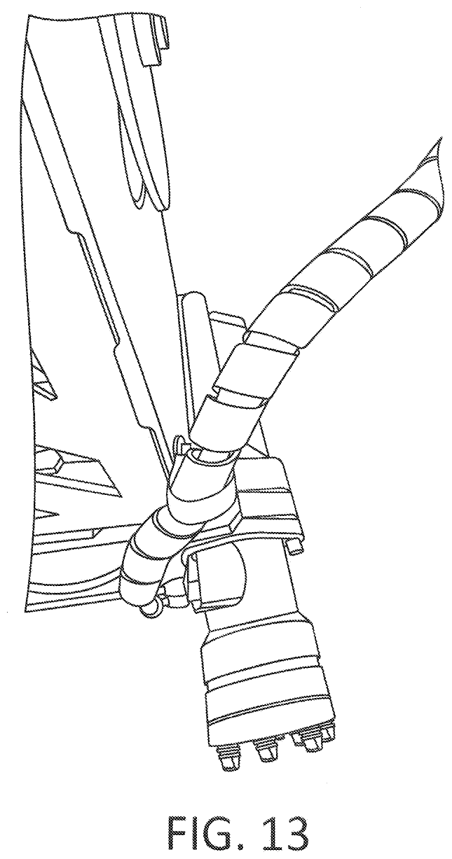

FIG. 13 depicts a second slew drive (the slew drive connects the tower to the turret), consistent with various embodiments;

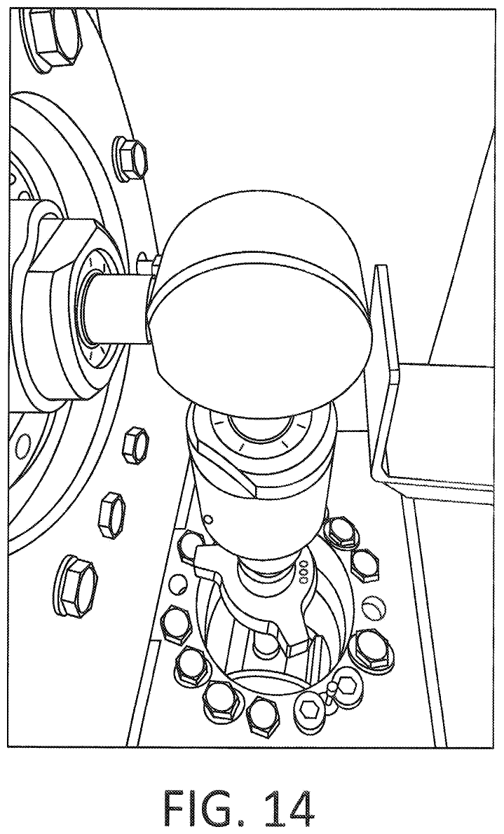

FIG. 14 depicts the one-inch-high pressure water fittings on the inside of the tower, consistent with various embodiments.

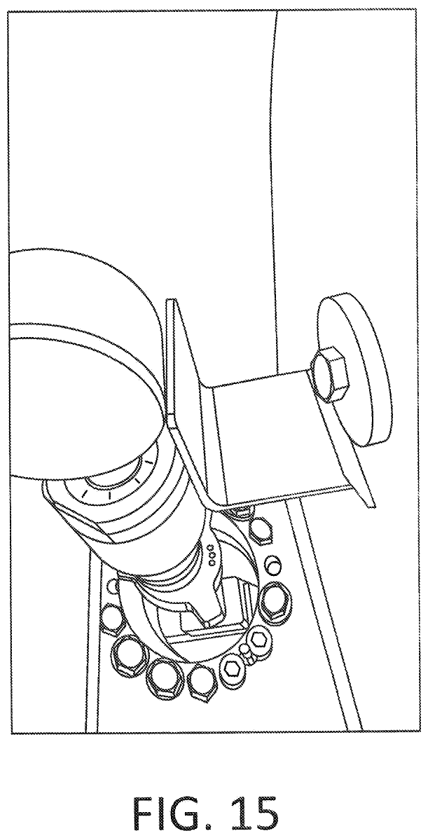

FIG. 15 illustrates the 90° swivel piece to the hammer lock to a 6″ nipple to another 90° swivel piece to the barrel, consistent with various embodiments. The figure further illustrates the inside of the tower connected to the second slew drive, consistent with various embodiments.

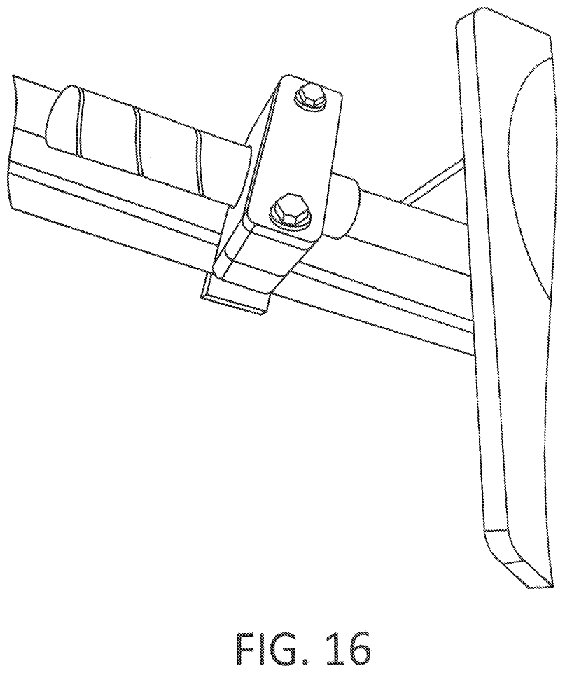

FIG. 16 depicts the barrel, barrel mounts, vibration collar and turret, region coming out from the system's arm to the stinger, consistent with various embodiments.

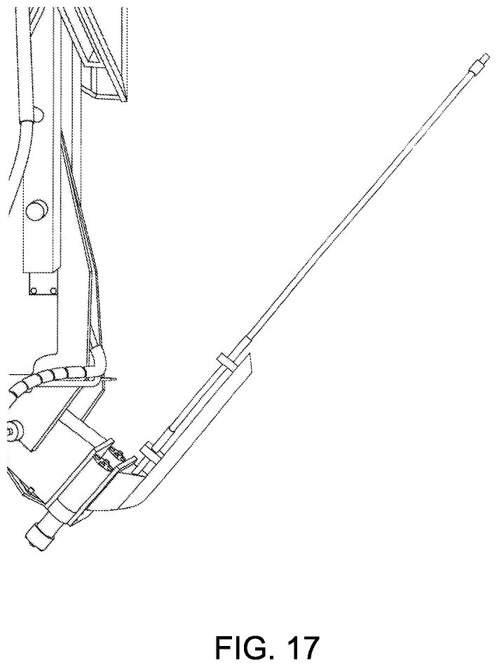

FIG. 17 illustrates the hydraulic arm rotating the stinger 360° up/down, illustrating how the stinger gun is positioned at a precision blasting point. The figure highlights the stinger connected to the turret connected to the slew drive connected to the tower connected to the boom mount. In one embodiment, the stinger movement mechanism is comprised of a 1″ high pressure quick-connect piece, connected to a 1″ 90°-degree bend piece, connected to a 1″ pressure swivel piece, connected to another 1″ 90°-degree bend piece, connected to another 1″ swivel piece, connected to another 1″-quick connect piece, connected to a 6″ nipple, connected to another 1″ 90°-degree bend piece, connected to a 1″×8″ rigid lance/pipe/barrel. The tip is a 1″ to ¾″ nozzle holder, wherein the nozzle is a Tungsten Carbide style linear material comprising a ¾″ diameter aperture with a #90 jet (in a preferred embodiment).

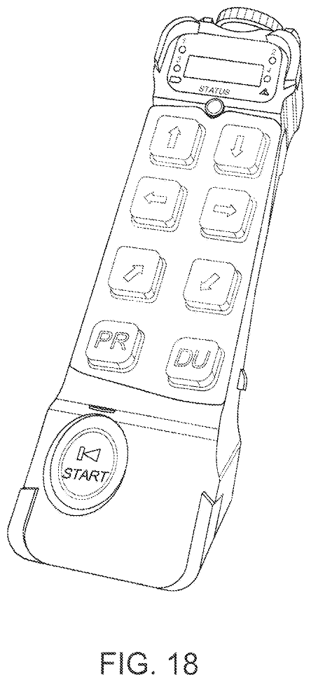

FIG. 18 illustrates the RF stinger controller, consistent with various embodiments. Six buttons control the stinger's movement, while two buttons control water flow. In some embodiments, the remote unit is an HBC radio remote control transmitter unit.

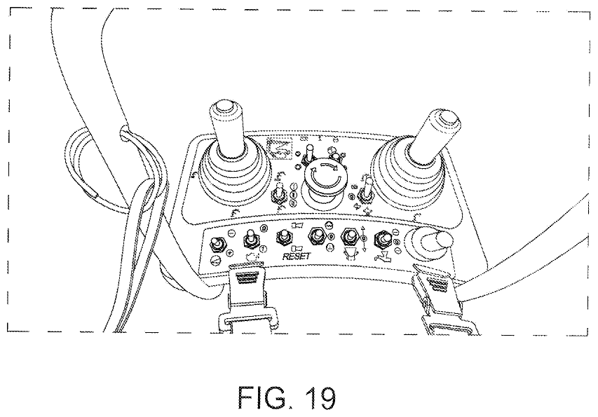

FIG. 19 illustrates the joystick boom control, consistent with various embodiments. Controls for the boom feature, in some embodiments, a handheld pendant-style joystick (4 functions). CNC wire-connected units (or manually operated levers) or RF controlled unit(s), or other appropriate controls may be used.

### ALTERNATIVE EMBODIMENTS

An industrial device for hydro-blasting debris in hard-to-reach places, the device having
a base at least one hydraulicly powered boom, the boom having a proximal end positioned at the at the base and a distal end positioned vertically above the proximal end, a boom controller, at least four electrohydraulic valves, at least one motor which drives the hydraulics, at least one hydraulic fluid reservoir, a tower assembly at the distal end of the boom which connects to a stinger solvent spray assembly, where the stinger assembly houses at least one solvent line,
where the stinger assembly comprises least a first slew drive and a second slew drive,
where each slew drive is fed by at least two hydraulic fluid lines and at least one power line;
where said lines run along the boom into the stinger assembly and ultimately to the stinger spray, the lines being securely fixed to the boom by brackets and bracket mounts which are fixed to the boom at substantially regular intervals, the intervals being between about 1′ apart and about 6′ apart, and where the brackets help dampen vibration at high water pressures up to 15000 lbs and ensure reliable water flow at these maximum pressures and reduce resultant stress that would otherwise quickly disassemble the mechanism and disrupt solvent flow, and
where the stinger assembly is moved by at least two slew drives for 360° motion along both a horizontal plane and a vertical plane, empowering a stinger spray nozzle to point in any direction, and where the boom and stinger together reach debris sites 180′ away from the base, wherein the slew drives connect to a rotating turret and a pivoting stinger assembly,
wherein the stinger assembly comprises at least
a lance shaft, a waterjet trigger mechanism, and a nozzle,
and wherein the stinger assembly is controlled by a two-way radio frequency stinger control system, said RF control system comprising at least a transmitter unit and a receiver unit;
wherein the receiver unit has at least four hydraulic fluid lines running therefrom,
wherein each hydraulic fluid line comprises at least one flow-rate valve.

The base can be a truck of sufficient mass to support the device's remaining components.

The boom can be a multi-jointed articulated arm hingedly fixed to the base, said arm capable of at least vertical motion.

The boom controller can be positioned inside a panel affixed to the boom.

The device can have a joystick-operated controller comprising at least six control features for movement and flow functions, and wherein said joystick-operated controller is an optionally detachable modular remote unit.

The solvent line can be a 1″ water line with optional fittings.

The stinger lance is usually a rigid metallic 1″ diameter pipe barrel. The stinger lance can be a barrel between about 3″ long and about 12″ long with a diameter of between about ½″ to a.

The stinger spray nozzle can be a Tungsten Carbide nozzle with a #90 jet™.

The RF stinger control system can have a manual or auto override safety system.

The device can also be a hydro-blasting device comprising a hydraulicly powered articulated main boom attached to an articulated robotic stinger arm, both apparatus' having a proximal end and a distal end; said blasting device further comprising a hydraulic turret assembly which rotates 360° along one axis,
further comprising a rotatable jet-support assembly mounted on the turret assembly,
said jet-support assembly having a proximal end and a distal end,
said jet-support assembly pivoting 360° along a second axis traversing the first axis perpendicular to the turret's axis,
and a hydro-jet wand mounted on the distal end of the support assembly such that
the turret assembly and jet-support assembly together give the jet-wand full 360° directional capacity; said boom, assembly and wand components being connectable to a high pressure water source, wherein the blasting device further comprises radio frequency control and drive means for operating the rotating turret and the pivoting jet-support assembly so as to position the stinger nozzle at any reachable position any available angle.

The rotating turret and pivoting jet-support assembly may each be driven by two dedicated slew drives.

The hydraulics may be controlled by at least four computer-operated cylinoids, each cylinoid having at least two hydraulic lines stemming therefrom.

The device may further comprise a high-pressure hose running through a central channel in the turret and jet support assemblies, said hose connected to the stinger assembly by coupling devices substantially evenly spaced along the boom, and wherein the hydraulic, power and water lines are secured to the boom by metal pipe-style mounted brackets, therein allowing water flow at up to 15000 lbs without undue structural or hose vibration.

The device may have at least one hose is sheathed in an isolation sleeve;

The coupling devices comprise mounts and brackets arranged along the boom, where the brackets are substantially metallic pipe-style brackets and ties.

The stinger assembly may have a substantially central channel for at least 1 fluid line, at least one 90° swivel piece to prevent hose-tangling, and at least one hammerlock to allow controlled 360° movement.

The device may further comprise at least one digital video camera and at least one monitor for stinger positioning and system monitoring.

The device of claim 11 further comprising an override safety system.

The device may be an industrial hydro-blasting device mounted on the far end of a concrete-pouring truck's boom, wherein the device comprises at least a lance shaft a waterjet trigger mechanism, and a nozzle,
wherein the lance, the jet trigger mechanism and the nozzle all have 360° range motion driven by a Radio Frequency controlled hydraulic turret and pivot mechanism.

### SPECIFICATIONS GENERALLY

In the Summary above and in this Detailed Description, and the Claims below, and in the accompanying drawings, reference is made to particular features of various embodiments of the invention. It is to be understood that the disclosure of embodiments of the invention in this specification includes all possible combinations of such particular features. For example, where a particular feature is disclosed in the context of a particular aspect or embodiment of the invention, or a particular claim, that feature can also be used-to the extent possible-in combination with and/or in the context of other particular aspects and embodiments of the invention, and in the invention generally.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

In the present disclosure, various features may be described as being optional, for example, through the use of the verb “may;”, or, through the use of any of the phrases: “in some embodiments,” “in some implementations,” “in some designs,” “in various embodiments,” “in various implementations,”, “in various designs,” “in an illustrative example,” or “for example;” or, through the use of parentheses. For the sake of brevity and legibility, the present disclosure does not explicitly recite each and every permutation that may be obtained by choosing from the set of optional features. However, the present disclosure is to be interpreted as explicitly disclosing all such permutations. For example, a system described as having three optional features may be embodied in seven different ways, namely with just one of the three possible features, with any two of the three possible features or with all three of the three possible features.

In the present disclosure, the term “any” may be understood as designating any number of the respective elements, i.e. as designating one, at least one, at least two, each or all of the respective elements. Similarly, the term “any” may be understood as designating any collection(s) of the respective elements, i.e. as designating one or more collections of the respective elements, a collection comprising one, at least one, at least two, each or all of the respective elements. The respective collections need not comprise the same number of elements.

In the present disclosure, all embodiments where “comprising” is used may have as alternatives “consisting essentially of,” or “consisting of.” In the present disclosure, any method or apparatus embodiment may be devoid of one or more process steps or components. In the present disclosure, embodiments employing negative limitations are expressly disclosed and considered a part of this disclosure.

Certain terminology and derivations thereof may be used in the present disclosure for convenience in reference only and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an embodiment “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose limit is the second number. For example, 25 to 100 mm means a range whose lower limit is 25 mm and upper limit is 100 mm.

Many suitable methods and corresponding materials to make each of the individual parts of embodiment apparatus are known in the art. According to an embodiment of the present invention, one or more of the parts may be formed by machining, CNC machined parts (also known as “subtractive” manufacturing), and injection molding, as will be apparent to a person of ordinary skill in the art. Metals, wood, thermoplastic and thermosetting polymers, resins and elastomers as may be described herein-above may be used. Many suitable materials are known and available and can be selected and mixed depending on desired strength and flexibility, preferred manufacturing method and particular use, as will be apparent to a person of ordinary skill in the art.

Any element in a claim herein that does not explicitly state “means for” performing a specified function, or “step for” performing a specific function, is not to be interpreted as a “means” or “step” clause as specified in 35 U.S.C. § 112 (f). Specifically, any use of “step of” in the claims herein is not intended to invoke the provisions of 35 U.S.C. § 112 (f). Elements recited in means-plus-function format are intended to be construed in accordance with 35 U.S.C. § 112 (f).

Recitation in a claim of the term “first” with respect to a feature or element does not necessarily imply the existence of a second or additional such feature or element.

The phrases “connected to,” “coupled to” and “in communication with” refer to any form of interaction between two or more entities, including mechanical, electrical, magnetic, electromagnetic, fluid, and thermal interaction. Two components may be functionally coupled to each other even though they are not in direct contact with each other. The term “abutting” refers to items that are in direct physical contact with each other, although the items may not necessarily be attached together.

The word “exemplary” is used herein to mean “serving as an example, instance, or illustration.” Any embodiment described herein as “exemplary” is not necessarily to be construed as preferred or advantageous over other embodiments. While the various aspects of the embodiments are presented in drawings, the drawings are not necessarily drawn to scale unless specifically indicated.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, Figure, or description thereof for the purpose of streamlining the disclosure. This method of disclosure, however, is not to be interpreted as reflecting an intention that any claim in this or any application claiming priority to this application require more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

According to an embodiment of the present invention, the communications means of the system may be, for instance, any means for communicating data over one or more networks or to one or more peripheral devices attached to the system. Appropriate communications means may include, but are not limited to, circuitry and control systems for providing wireless connections, wired connections, cellular connections, data port connections, Bluetooth connections, or any combination thereof. One of ordinary skill in the art would appreciate that there are numerous communications means that may be utilized with embodiments of the present invention, and embodiments of the present invention are contemplated for use with any communications means.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general-purpose hardware and computer instructions; and so on-any and all of which may be generally referred to herein as a “circuit,” “module,” or “system.”

While the foregoing drawings and description may set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. An industrial device for hydro-blasting debris in hard-to-reach places, the device comprising
a base
at least one hydraulicly powered boom
said boom having a proximal end positioned at the at the base and a distal end positioned vertically above the proximal end,
a boom controller,
at least four electrohydraulic valves,
at least one motor which drives the hydraulics,
at least one hydraulic fluid reservoir,
a tower assembly at the distal end of the boom which connects to a stinger solvent spray assembly,
wherein said stinger assembly houses at least one solvent line,
wherein the stinger assembly comprises least a first slew drive and a second slew drive,
wherein each slew drive is fed by at least two hydraulic fluid lines and at least one power line;
where said lines run along the boom into the stinger assembly and ultimately to the stinger spray,
said lines being securely fixed to the boom by brackets and bracket mounts which are fixed to the boom
at substantially regular intervals,
said intervals being between about 1′ apart and about 6′ apart, and
where the brackets help dampen vibration at high water pressures up to 15000 lbs and ensure reliable water flow at these maximum pressures and reduce resultant stress that would otherwise quickly disassemble the mechanism and disrupt solvent flow, and
where the stinger assembly is moved by at least two slew drives for 360° motion along both a horizontal plane and a vertical plane, empowering a stinger spray nozzle to point in any direction, and
wherein the slew drives connect to a rotating turret and a pivoting stinger assembly,
wherein the stinger assembly comprises at least
a lance shaft
a waterjet trigger mechanism, and
a nozzle,
and wherein the stinger assembly is controlled by a two-way radio frequency stinger control system,
said RF control system comprising at least a transmitter unit and a receiver unit;
wherein the receiver unit has at least four hydraulic fluid lines running therefrom,
wherein each hydraulic fluid line comprises at least one flow-rate valve.

2. The invention of claim 1 wherein the base is a truck of sufficient mass to support the device's remaining components.

3. The invention of claim 1 wherein the boom is a multi-jointed articulated arm hingedly fixed to the base, said arm capable of at least vertical motion.

4. The invention of claim 1 wherein the boom controller is positioned inside a panel affixed to the boom.

5. The invention of claim 1 further comprising a joystick-operated controller comprising at least six control features for movement and flow functions, and wherein said joystick-operated controller is an optionally detachable modular remote unit.

6. The invention of claim 1 wherein the solvent line is a 1″ water line with optional fittings.

7. The invention of claim 1 wherein the stinger lance is a rigid metallic 1″ diameter pipe barrel.

8. The invention of claim 1 wherein the stinger lance is a barrel between about 3″ long and about 12″ long with a diameter of between about ½″ to about 2″.

9. The invention of claim 1 wherein the stinger spray nozzle is a Tungsten Carbide nozzle with a #90 jet™.

10. The invention of claim 1 wherein the RF stinger control system further comprises an override safety system.

11. A hydro-blasting device comprising a hydraulicly powered articulated main boom attached to an articulated robotic stinger arm, both apparatus' having a proximal end and a distal end;
said blasting device further comprising a hydraulic turret assembly which rotates 360° along one axis,
further comprising a rotatable jet-support assembly mounted on the turret assembly,
said jet-support assembly having a proximal end and a distal end,
said jet-support assembly pivoting 360° along a second axis traversing the first axis perpendicular to the turret's axis,
and a hydro-jet wand mounted on the distal end of the support assembly such that the turret assembly and jet-support assembly together give the jet-wand full 360° directional capacity;
said boom, assembly and wand components being connectable to a high pressure water source,
wherein the blasting device further comprises radio frequency control and drive means for operating the rotating turret and the pivoting jet-support assembly so as to position the stinger nozzle at any reachable position any available angle.

12. The device of claim 11 wherein the rotating turret and pivoting jet-support assembly are each driven by two dedicated slew drives.

13. The device of claim 11 where the hydraulics are controlled by at least four computer-operated cylinoids, each cylinoid having at least two hydraulic lines stemming therefrom.

14. The device of claim 11 further comprising a high-pressure hose running through a central channel in the turret and jet support assemblies,
said hose connected to the stinger assembly by
coupling devices substantially evenly spaced along the boom, and
wherein the hydraulic, power and water lines are secured to the boom by metal pipe-style mounted brackets, therein allowing water flow at up to 15000 lbs without undue structural or hose vibration.

15. The device of 11 wherein at least one hose is sheathed in an isolation sleeve;

16. The device of claim 11 wherein the coupling devices comprise mounts and brackets arranged along the boom, where the brackets are substantially metallic pipe-style brackets and ties.

17. The device of claim 11 wherein the stinger assembly comprises a substantially central channel for at least 1 fluid line, at least one 90° swivel piece to prevent hose-tangling, and at least one hammerlock to allow controlled 360° movement.

18. The device of claim 11 further comprising at least one digital video camera and at least one monitor for stinger positioning and system monitoring.

19. The device of claim 11 further comprising an override safety system.

20. An industrial hydro-blasting device mounted on the far end of a concrete-pouring truck's boom,
wherein the device comprises at least
a lance shaft
a waterjet trigger mechanism, and
a nozzle,
wherein the lance, the jet trigger mechanism and the nozzle all have 360° range motion driven by a Radio Frequency controlled hydraulic turret and pivot mechanism.
